(19) United States
(12) Patent Application Publication
(10) Pub. No.: US 2016/0125498 A1
(43) Pub. Date: May 5, 2016

(54) RUN-TIME UTILIZATION OF CONTEXTUAL PREFERENCES FOR A SEARCH INTERFACE

(71) Applicant: eBay inc., San Jose, CA (US)

(72) Inventors: Rakesh Setty, Sunnyvale, CA (US); Manas Haribhai Somaiya, Sunnyvale, CA (US); Rajyashree Mukherjee, Fremont, CA (US)

(21) Appl. No.: 14/716,662

(22) Filed: May 19, 2015

Related U.S. Application Data
(60) Provisional application No. 62/075,067, filed on Nov. 4, 2014.

(51) Int. Cl. G06Q 30/06; G06F 17/30

(52) U.S. Cl. CPC G06Q 30/0627; G06F 17/30867; G06F 17/30528; G06F 17/30554; G06F 17/30345

(57) ABSTRACT

The present disclosure is directed to apparatuses, systems, and methods for enhancing search results based on a user's interaction history with a publication system (e.g., an electronic marketplace). As described herein, embodiments may infer various refinements for search queries; these refinements are based, at least in part, on the user's previous interactions with the search platform (e.g., from one or more previous sessions) of the publication system. In other words, as the user continuously interacts with the search platform of the publication system across multiple sessions, one or more of refinements may be inferred to help make the search results more relevant to the user.

### PRIORITY CLAIM

This application claims the benefit of U.S. Provisional Application No. 62/075,067, filed Nov. 4, 2014, the entire contents of which are hereby incorporated by reference herein.

### TECHNICAL FIELD

The present application relates generally to the technical field of data processing and, in particular, to enhancing the results generated in a search experience.

### BACKGROUND

A publication system may provide a user interface for a user to access a wide variety of items and/or services for sale. The publication system may be accessed using a web browser, such as Google Chrome, Mozilla Firefox, Microsoft Internet Explorer, and other such web browsers. The publication system may accept search queries via the web browser to help a user find a particular offered item, such as a good or service. In response, the publication system may display a set of search results that match, and/or are related to, the received search query. However, the user may not be familiar with all of the possible refinements allowed by a particular search platform, or these refinements may not be easily discoverable to the user.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 illustrates a network architecture of an exemplary system, according to aspects of the disclosure.

FIG. 2 illustrates exemplary applications executable by one or more application servers, according to aspects of the disclosure.

FIG. 3 illustrates an exemplary client machine, according to aspects of the disclosure.

FIG. 4 is a block diagram illustrating components of a machine, according to some example embodiments, able to read instructions from a machine-readable medium and perform any one or more of the methodologies discussed herein, according to aspects of the disclosure.

FIG. 5 is a block diagram illustrating components of a machine able to read instructions from a machine-readable medium and perform any one or more of the methodologies discussed herein, according to aspects of the disclosure.

FIG. 6 illustrates an exemplary logic flow, according to aspects of the disclosure.

FIG. 7A-7C illustrate a web page of a publication system configured to receive search queries for items offered for sale by the electronic marketplace, according to aspects of the disclosure.

FIG. 8 illustrates a web page of a publication system displaying search results in response to a received search query, according to aspects of the disclosure.

FIG. 9 illustrates exemplary system components according to aspects of the disclosure.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the subject matter may be practiced without these specific details. In general, well-known instruction instances, protocols, structures, and techniques have not been shown in detail.

The present disclosure is directed to apparatuses, systems, and methods for enhancing search results based on recent user interactions. As described herein, embodiments may infer various refinements for search queries; these refinements are based, at least in part, on the user's recent interactions with the search platform (e.g., within a current session). In other words, as the user is interacting with the search platform, one or more of refinements may be inferred to help make the search results more relevant to the user.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to execute the instructions.

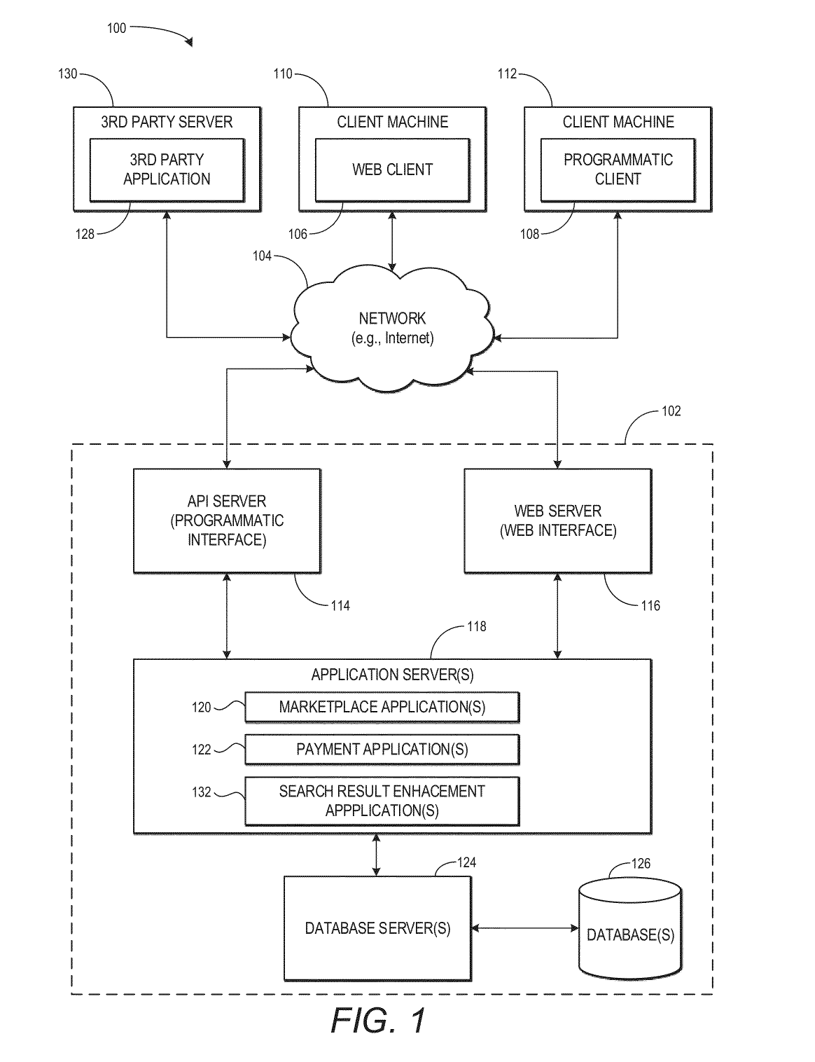

FIG. 1 is a network diagram depicting a client-server system 100, according to aspects of the disclosure. A networked system 102, in the example forms of a network-based marketplace or publication system, provides server-side functionality, via a network 104 (e.g., the Internet or a wide area network (WAN)) to one or more client machines. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications, such as a marketplace application(s) 120, a payment application(s) 122, and one or more search result enhancement applications 132. The application server(s) 118 are, in turn, shown to be coupled to one or more database servers 124 that facilitate access to one or more databases 126.

The marketplace application(s) 120 is to provide a number of marketplace functions and services to users who access the networked system 102. The payment application(s) 122 is to likewise provide a number of payment services and functions to users. The payment application(s) 122 is to allow users to accumulate value (e.g., in a commercial currency, such as the U.S. dollar, or a proprietary currency, such as “points”) in accounts, and then later to redeem the accumulated value for products (e.g., goods or services) that are made available via the marketplace application(s) 120.

As discussed further below, the price ranges and price points are to be collected from one or more sources, such as items being offered for sale through the electronic marketplace, items being offered at auctions hosted by the electronic marketplace, items having been previously sold through the electronic marketplace, external sources (e.g., application-programming interfaces to other electronic marketplaces), and other such sources. Thus, when a search query is received for items being offered for sale through the electronic marketplace, the application server(s) 118 are to provide one or more price ranges for the prices of search results that correspond to the received search query.

The application server(s) 118 are to also include one or more search result enhancement application(s) 132 to automatically learn default parameters in a search experience. As described in further detail below, embodiments are to utilize a user's activity on a search platform across multiple sessions to infer various refinements that might help the user to narrow the results to be more relevant to his interests. In other words, the user's past interactions with an electronic marketplace, including his interaction with its search platform during previous sessions, are used to infer one or more of refinements to help make the results more relevant for the user. More relevant results are more likely to lead to purchases by the user.

While the marketplace application(s) 120, the payment application(s) 122, and the search result enhancement application(s) 132 are shown in FIG. 1 to form part of the networked system 102, it will be appreciated that, in alternative embodiments, the applications 120, 122, and 132 are to be separate or distinct from the system 102. For example, the payment application(s) 122 are to form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The marketplace application(s) 120, the payment application(s) 122, and the search result enhancement application(s) 132 could also be implemented as standalone software programs, which do not necessarily have networking capabilities.

The web client 106 is to access the marketplace application(s) 120, the payment application(s) 122, and the search result enhancement application(s) 132 via the web interface supported by the web server 116. Similarly, the programmatic client 108 is to access the various services and functions provided by the applications 120, 122, and 132 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, payment, or advertising functions that are supported by the relevant applications of the networked system 102.

The networked system 102 is to provide a number of publishing, listing, and price-setting mechanisms whereby a seller may list (or publish information concerning) goods or services for sale, a buyer may express interest in or indicate a desire to purchase such goods or services, and a price may be set for a transaction pertaining to the goods or services.

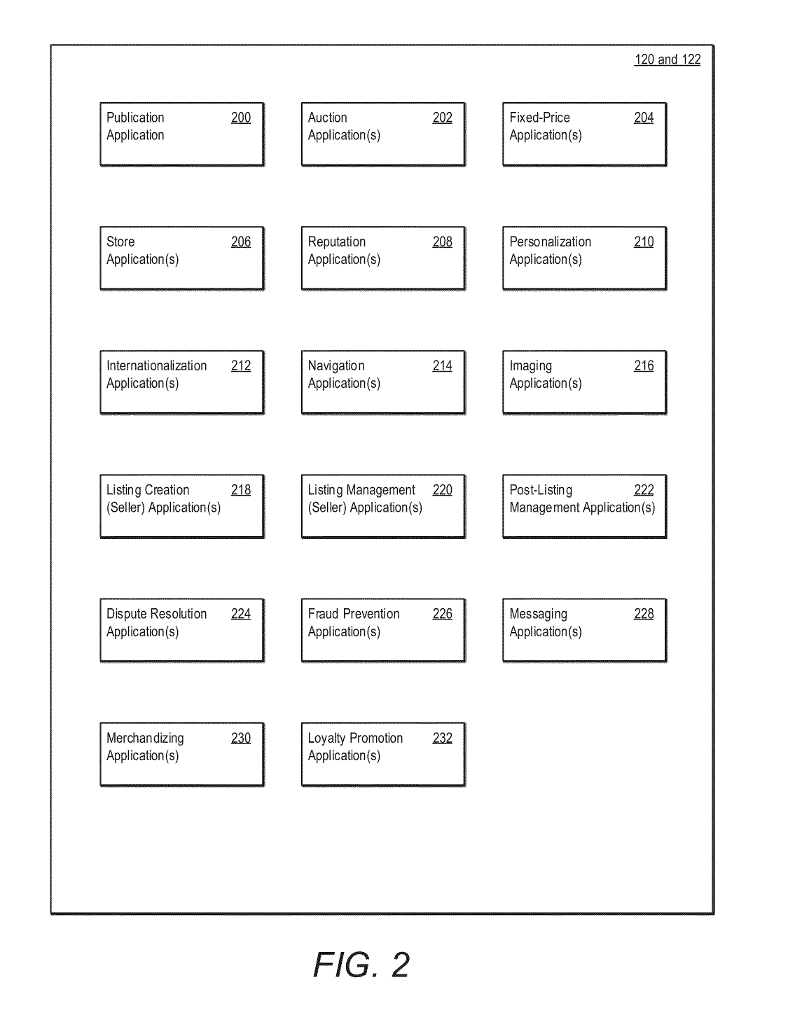

FIG. 2 illustrates exemplary applications that may be executable by the foregoing application server(s) 118 to support the aforementioned mechanisms. To this end, the marketplace application 120 and the payment application 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 are to also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example, a user may, utilizing one of the appropriate personalization applications 210, create a personalized reference page on which information regarding transactions to which the user is (or has been) a party may be viewed. Further, one of the personalization applications 210 may enable a user to personalize listings and other aspects of their interactions with the networked system 102 and other parties.

The networked system 102 is to support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via web server 116.

Navigation of the networked system 102 is to be facilitated by one or more navigation applications 214. For example, a search application (as an example for one of the navigation applications 214) is to enable key word searches of listings published via the networked system 102. A browse application is to allow users to browse various category, catalogue, or inventory data structures according to which listings may be classified within the networked system 102. Various others of the navigation applications 214 may be provided to supplement the search and browsing applications.

In order to make the listings available via the networked system 102 as visually informing and attractive as possible, the applications 120 and 122 include one or more imaging applications 216, which users may utilize to upload images for inclusion within listings. The imaging applications 216 also operate to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, one or more post-listing management applications 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute may not be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and may be offered a reward for which accumulated loyalty points may be redeemed.

Furthermore, and referring back to FIG. 1, the search result enhancement application(s) 132 leverage one or more of the applications 200-232 in dynamically determining popular price ranges for one or more items based on one or more received search queries and for providing a meaningful display of this information. In other words, the search result enhancement application(s) 132 may invoke or use data gathered by the applications 200-232 in determining popular price ranges and/or points for a given search query, and which listings are ultimately displayed to the user as popular price ranges. For example, the search result enhancement application(s) 132 may obtain one or more search queries via the navigation application(s) 214, and prices for the various listings via the auction application(s) 202 and/or the fixed-price application(s) 204. The search result enhancement application(s) 132 may also access other applications shown in FIG. 2, such as the store application(s) 206, to obtain prices for items that were previously sold.

As the search result enhancement application(s) 132 may be integrated (e.g., directly or indirectly) with the application server(s) 118, the search result enhancement application(s) 132 may leverage the data obtained from the applications 200-232 and provide relatively up-to-date or current price ranges for items being offered through the electronic marketplace. This integration may further extend to the one or more database server(s) 124 and/or database(s) 126 in communication with the application server(s) 118. As discussed below, the search result enhancement application(s) 132 may access stored information, such as session logs, to dynamically determine popular price ranges for one or more items based on one or more received search queries.

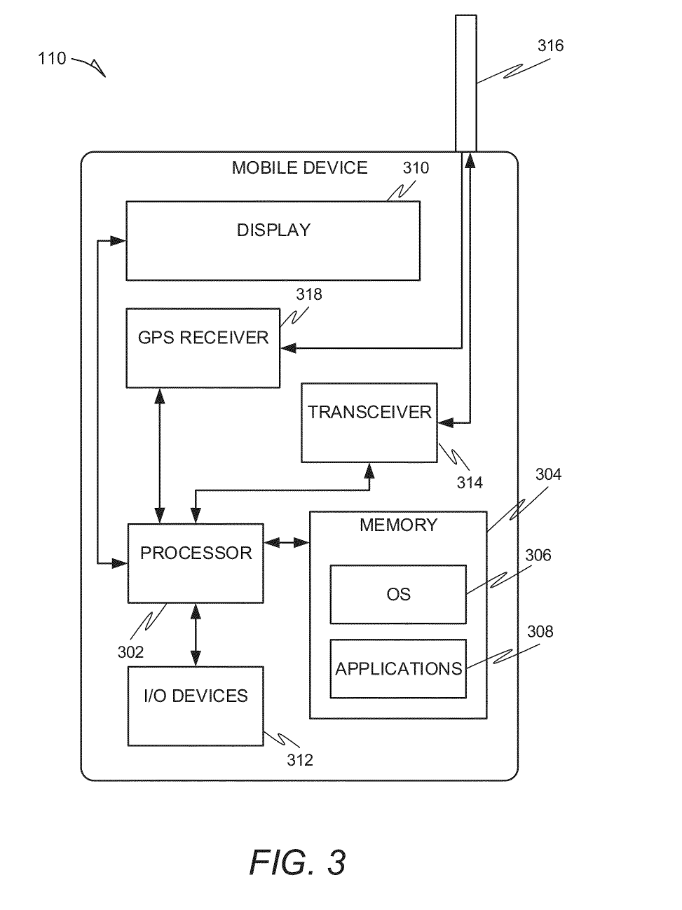

FIG. 3 illustrates one example for one of the client machines 110, in accordance with aspects of the disclosure. In one embodiment, the client machine 110 may be a mobile device. The mobile device may include a processor 302. The processor 302 may be any of a variety of different types of commercially available processors suitable for mobile devices (e.g., an ARM architecture microprocessor, a Microprocessor without Interlocked Pipeline Stages (MIPS) architecture processor, or another type of processor). A memory 304, such as a random access memory (RAM), a Flash memory, or other type of memory, is typically accessible to the processor 302. The memory 304 may be adapted to store an operating system (OS) 306, as well as application programs 308, such as a mobile location enabled application that may provide location-based services to a user. The processor 302 may be coupled, either directly or via appropriate intermediary hardware, to a display 310 and to one or more input/output (I/O) devices 312, such as a keypad, a touch panel sensor, a microphone, and the like. In some embodiments, display 310 comprises a touchscreen display capable of functioning as an I/O device. Similarly, in some embodiments, the processor 302 may be coupled to a transceiver 314 that interfaces with an antenna 316. The transceiver 314 may be configured to both transmit and receive cellular network signals, wireless data signals, or other types of signals via the antenna 316, depending on the nature of the mobile device 110. Further, in some configurations, a GPS receiver 318 may also make use of the antenna 316 to receive GPS signals.

The applications 308 of the client mobile device 110 may further include one or more browser applications, such as mobile browser applications, which may be used to provide a user interface to permit the user to browse information available over the network interface. The applications 308 may further include one or more provider-specific mobile applications (alternatively referred to herein as “mobile apps”), downloaded (e.g., downloaded by the user from a mobile software distribution platform) and resident on the client mobile device 110, that enable the user to access content through the mobile app in addition to said mobile browser application.

As referred to herein, mobile browsers and mobile apps may describe computer programs designed to run specifically on mobile devices such as smartphones, tablet computers, other handheld computing devices, etc. Mobile browsers and mobile apps may be designed with consideration to the constraints (e.g., low-power processors, limited memory, etc.) and features (e.g., location identification capabilities using geo-location sensors, integrated cellular telephone connectivity, etc.) of mobile devices. Mobile browsers and mobile apps may also implement mobile user interface (UI) designs that consider constraints of the screen size of the display 310, touchscreen capabilities of the display 310, etc.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry (e.g., a FPGA or an ASIC).

A computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments. It is contemplated that any features of any embodiments disclosed herein may be combined with any other features of any other embodiments disclosed herein. Accordingly, any such hybrid embodiments are within the scope of the present disclosure.

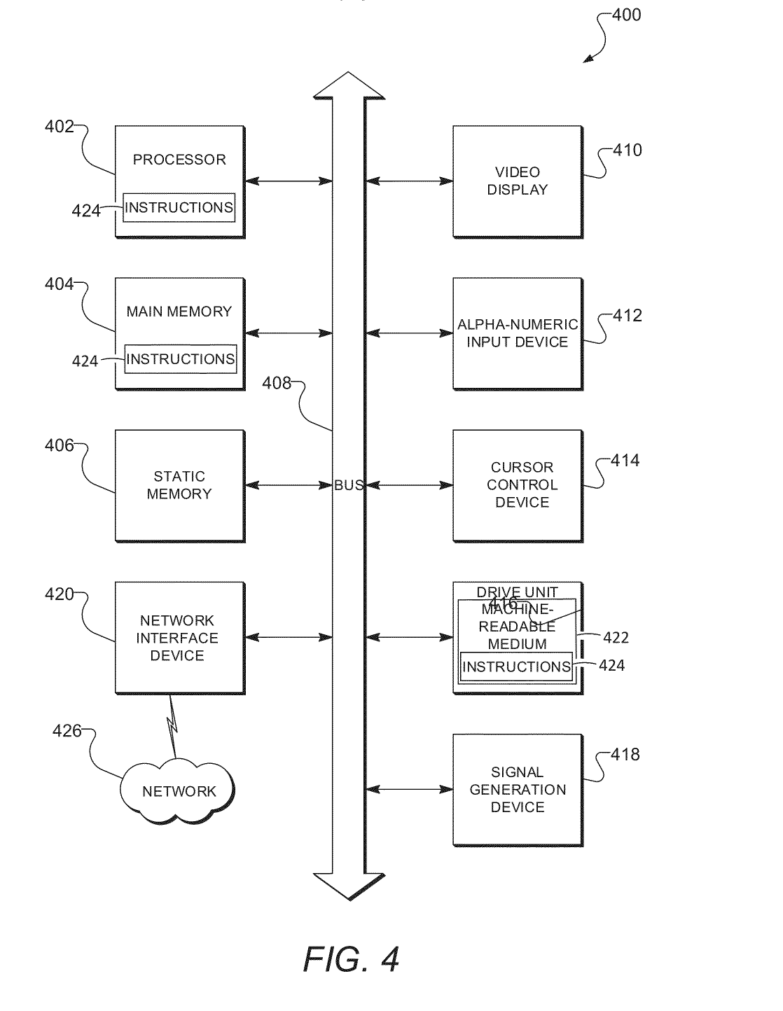

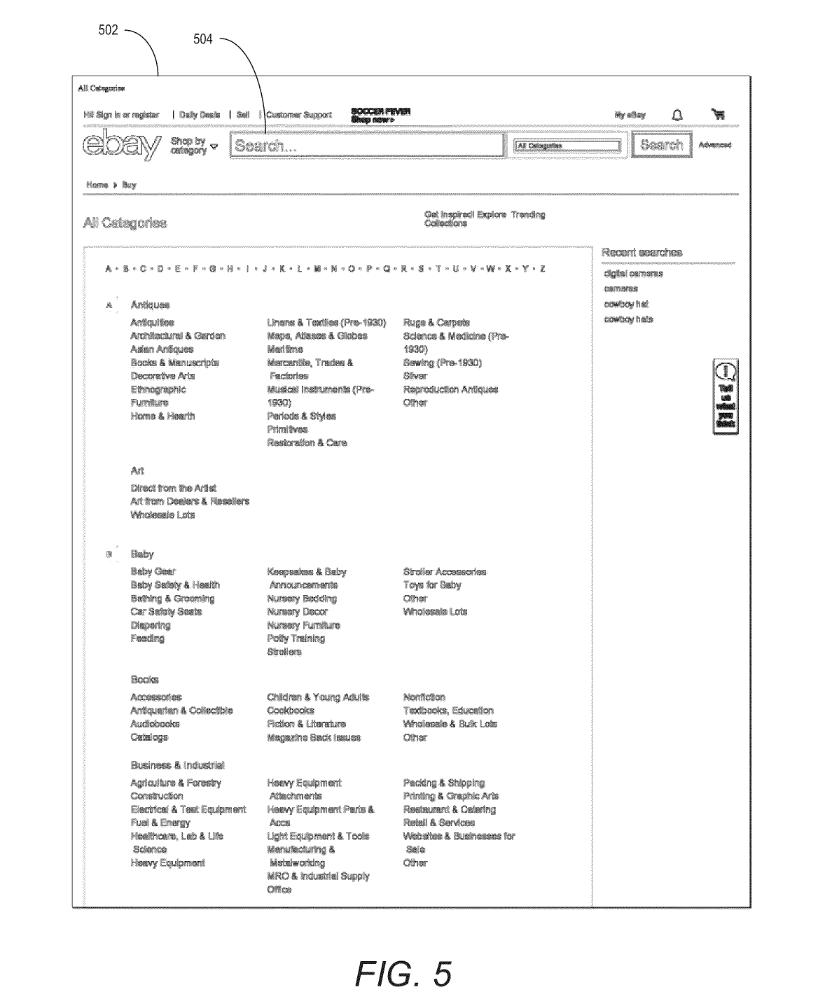

FIG. 4 is a block diagram 400 illustrating a representative software architecture 402, which may be used in conjunction with various hardware architectures herein described according to aspects of the disclosure. FIG. 4 is merely a non-limiting example of a software architecture 402 and it will be appreciated that many other architectures may be implemented to facilitate the functionality described herein. The software architecture 402 may be executing on hardware such as machine 500 of FIG. 5 that includes, among other things, processors 510, memory 530, and I/O components 550. A representative hardware layer 404 is illustrated and can represent, for example, the machine 500 of FIG. 5. The representative hardware layer 404 comprises one or more processing units 406 having associated executable instructions 408. Executable instructions 408 represent the executable instructions of the software architecture 402, including implementation of the methods, modules and so forth described herein. Hardware layer 404 also includes memory and/or storage modules 410, which also have executable instructions 408. Hardware layer 404 may also comprise other hardware as indicated by 412 which represents any other hardware of the hardware layer 404, such as the other hardware illustrated as part of machine 500.

In the example architecture of FIG. 4, the software architecture 402 may be conceptualized as a stack of layers where each layer provides particular functionality. For example, the software architecture 402 may include layers such as an operating system 414, libraries 416, frameworks/middleware 418, applications 420 and presentation layer 444. Operationally, the applications 420 and/or other components within the layers may invoke application programming interface (API) calls 424 through the software stack and receive a response, returned values, and so forth illustrated as messages 426 in response to the API calls 424. The layers illustrated are representative in nature and not all software architectures 402 have all layers. For example, some mobile or special purpose operating systems 414 may not provide a frameworks/middleware layer 418, while others may provide such a layer. Other software architectures may include additional or different layers.

The operating system 414 may manage hardware resources and provide common services. The operating system 414 may include, for example, a kernel 428, services 430, and drivers 432. The kernel 428 may act as an abstraction layer between the hardware and the other software layers. For example, the kernel 428 may be responsible for memory management, processor management (e.g., scheduling), component management, networking, security settings, and so on. The services 430 may provide other common services for the other software layers. The drivers 432 may be responsible for controlling or interfacing with the underlying hardware. For instance, the drivers 432 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 416 may provide a common infrastructure that may be utilized by the applications 420 and/or other components and/or layers. The libraries 416 typically provide functionality that allows other software modules to perform tasks in an easier fashion than to interface directly with the underlying operating system 414 functionality (e.g., kernel 428, services 430 and/or drivers 432). The libraries 416 may include system 434 libraries (e.g., C standard library) that may provide functions such as memory allocation functions, string manipulation functions, mathematic functions, and the like. In addition, the libraries 416 may include API libraries 436 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 416 may also include a wide variety of other libraries 438 to provide many other APIs to the applications 420 and other software components/modules.

The frameworks 418 (also sometimes referred to as middleware) may provide a higher-level common infrastructure that may be utilized by the applications 420 and/or other software components/modules. For example, the frameworks 418 may provide various graphic user interface (GUI) functions, high-level resource management, high-level location services, and so forth. The frameworks 418 may provide a broad spectrum of other APIs that may be utilized by the applications 420 and/or other software components/modules, some of which may be specific to a particular operating system or platform.

The applications 420 include built-in applications 440 and/or third party applications 442. Examples of representative built-in applications 440 may include, but are not limited to, a contacts application, a browser application, a book reader application, a location application, a media application, a messaging application, and/or a game application. Third party applications 442 may include any of the built in applications as well as a broad assortment of other applications. In a specific example, the third party application 442 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 442 may invoke the API calls 424 provided by the mobile operating system such as operating system 414 to facilitate functionality described herein.

The applications 420 may utilize built in operating system functions (e.g., kernel 428, services 430 and/or drivers 432), libraries (e.g., system 434, APIs 436, and other libraries 438), frameworks/middleware 418 to create user interfaces to interact with users of the system. Alternatively, or additionally, in some systems interactions with a user may occur through a presentation layer, such as presentation layer 444. In these systems, the application/module “logic” can be separated from the aspects of the application/module that interact with a user.

The search modules 401 to execute the search result enhancement operations described herein may comprise any combination of modules included in the applications 420, the firmware/middleware 418, the libraries 416, and the operating system 414.

Some software architectures utilize virtual machines. In the example of FIG. 4, this is illustrated by virtual machine 448. A virtual machine creates a software environment where applications/modules can execute as if they were executing on a hardware machine (such as the machine 500 of FIG. 5, for example). A virtual machine is hosted by a host operating system (operating system 414 in FIG. 4) and typically, although not always, has a virtual machine monitor 446, which manages the operation of the virtual machine as well as the interface with the host operating system (i.e., operating system 414). A software architecture executes within the virtual machine such as an operating system 450, libraries 452, frameworks/middleware 454, applications 456 and/or presentation layer 458. These layers of software architecture executing within the virtual machine 448 can be the same as corresponding layers previously described or may be different.

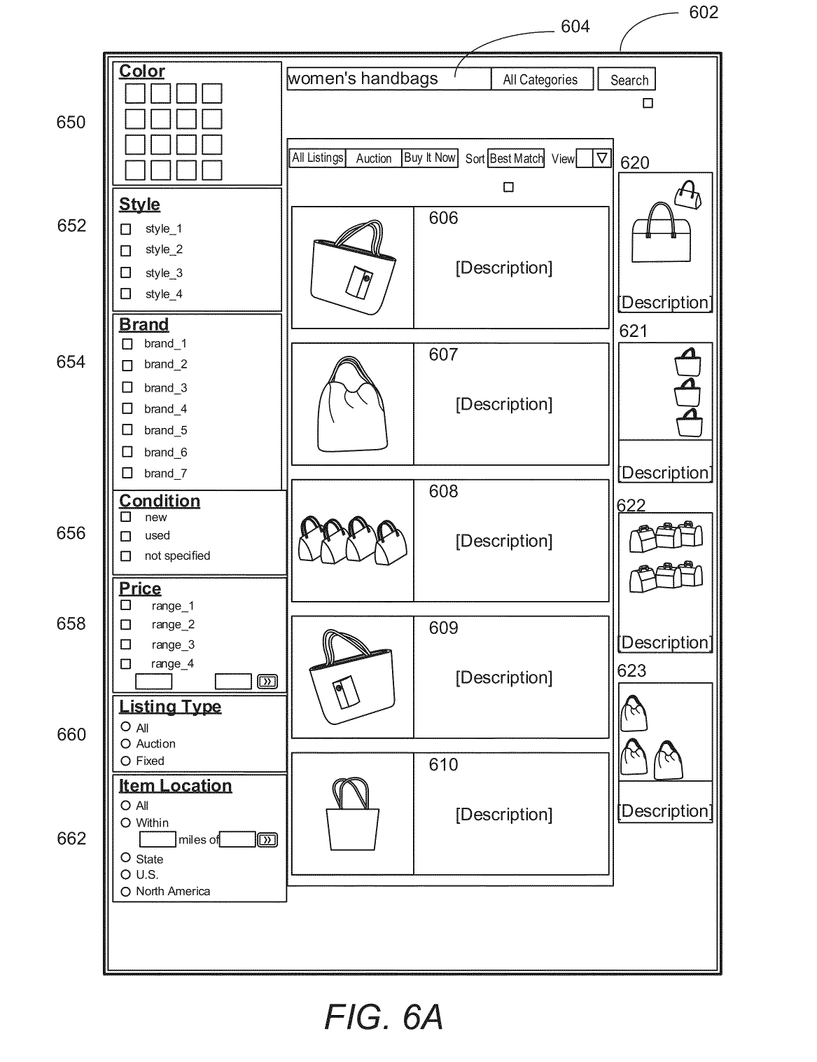

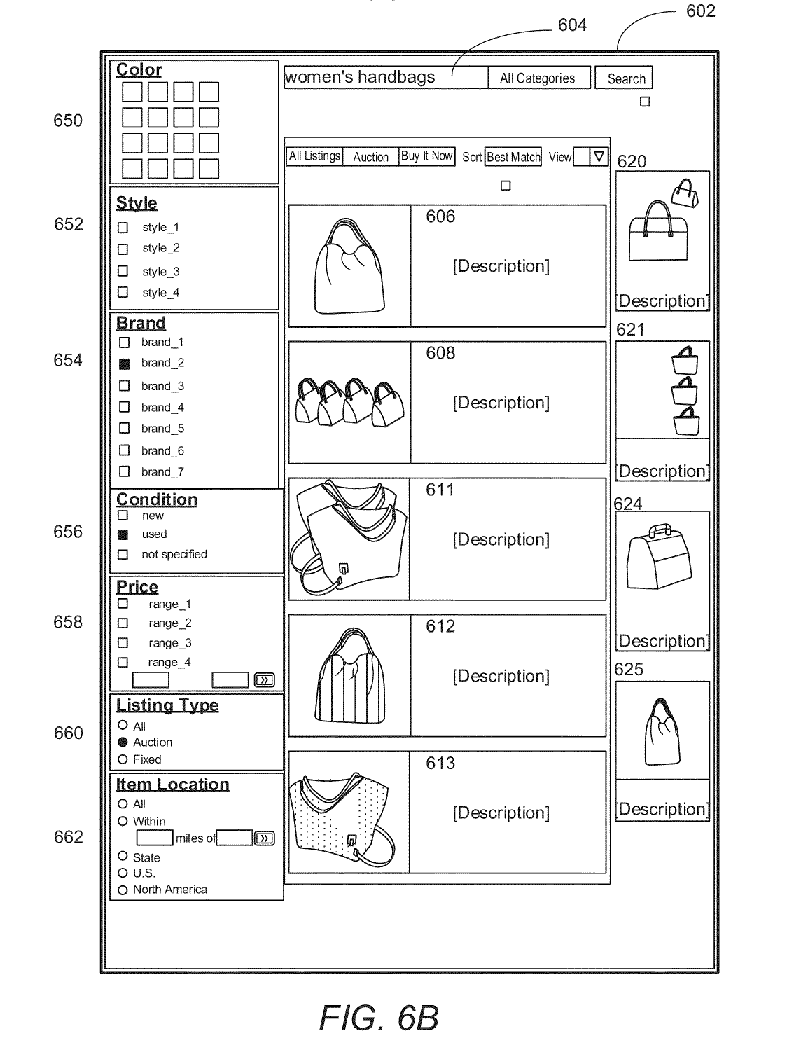

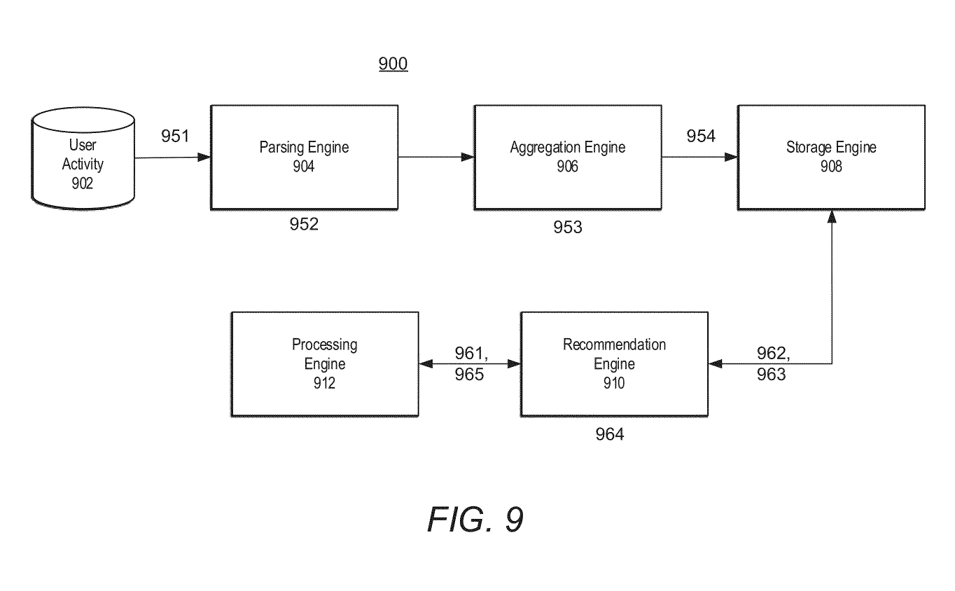

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. For example the instructions may cause the machine to execute the flow diagrams of FIG. 6 and FIG. 9. Additionally, or alternatively, the instructions may implement the search enhancement modules described herein, and so forth. The instructions transform the general, non-programmed machine into a particular machine programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 512 and processor 514 that may execute instructions 516. The term “processor” is intended to include a multi-core processor that may comprise two or more independent processors (sometimes referred to as “cores”) that may execute instructions contemporaneously. Although FIG. 5 shows multiple processors, the machine 500 may include a single processor with a single core, a single processor with multiple cores (e.g., a multi-core process), multiple processors with a single core, multiple processors with multiples cores, or any combination thereof.

The memory/storage 530 may include a memory 532, such as a main memory, or other memory storage, and a storage unit 536, both accessible to the processors 510 such as via the bus 502. The storage unit 536 and memory 532 store the instructions 516 embodying any one or more of the search enhancement methodologies or functions described herein. The instructions 516 may also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of processors 510 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine 500 (e.g., processors 510), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562 among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via coupling 582 and coupling 572 respectively. For example, the communication components 564 may include a network interface component or other suitable device to interface with the network 580. In further examples, communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a Universal Serial Bus (USB)).

Moreover, the communication components 564 may detect identifiers or include components operable to detect identifiers. For example, the communication components 564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 564, such as, location via Internet Protocol (IP) geo-location, location via Wi-Fi® signal triangulation, location via detecting a NFC beacon signal that may indicate a particular location, and so forth.

In various example embodiments, one or more portions of the network 580 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or other type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., hypertext transfer protocol (HTTP)). Similarly, the instructions 516 may be transmitted or received using a transmission medium via the coupling 572 (e.g., a peer-to-peer coupling) to devices 570. The term “transmission medium” shall be taken to include any intangible medium that is capable of storing, encoding, or carrying instructions 516 for execution by the machine 500, and includes digital or analog communications signals or other intangible medium to facilitate communication of such software.

FIG. 6 illustrates an exemplary logic flow according to aspects of the disclosure. An operation to monitor user activities, related to a plurality of item listings at an electronic marketplace, during a plurality of data communication sessions between the user and the electronic marketplace is executed (block 602). In some embodiments, the plurality of data communication sessions between the user and the electronic marketplace comprise data communication sessions authenticated via a user login identifier (ID). In some of these embodiments, the plurality of data communication sessions between the user and the electronic marketplace comprise data communication sessions is further authenticated via a cookie stored on the client device.

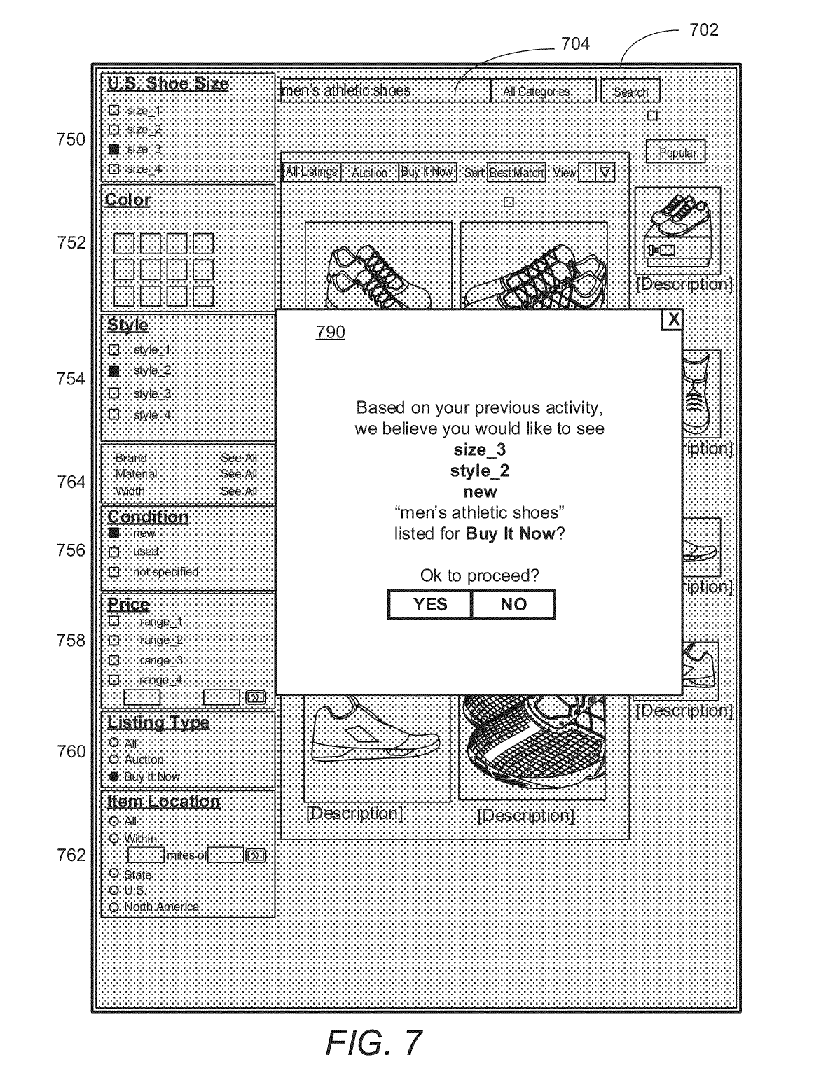

FIG. 7A illustrates a web page 702 of a publication system (e.g., an electronic marketplace) configured to receive search queries for items offered for sale by the electronic marketplace according to aspects of the disclosure. The web page 702 is to include an element, such as a text entry box 704, where the user is to provide a search query to search for listings offered by the electronic marketplace. The web page 702 and subsequent exemplary web pages illustrated and described below may alternatively comprise mobile browser or mobile app implementations in other embodiments.

A standard search experience in a typical electronic marketplace involves applying multiple refinements by the user to narrow the results returned to the user. Many users may not be familiar with all the possible refinements allowed by a particular search platform, or these refinements may not be easily discoverable to the user.

For example, an electronic marketplace may display user selectable refinements such as item filters (discussed in further detail below with respect to the illustrations of FIG. 7B and FIG. 7C). In general, most users may not apply all these refinements before browsing through the results. For example, if a user is searching for a specific brand of shoes, it is not clear from the keyword itself what category (e.g., men's shoes, formal wear, sportswear, color, size, etc.) he is interested in. Depending on the familiarity or context of the user (e.g., the user may not yet be sure of his search preferences), he may or may not apply all the various refinements that would make the results more relevant.

Referring back to FIG. 6, E-commerce shopping experiences include of two main types of content—search results and a product listings page. They are either implemented as separate entities, or combined in to a single seamless experience. The search results page usually includes many components—for example, current search context, a list of product listings matching the search context, additional modules to change (refine, pivot, etc.) the current search context, interaction elements, promotional links to a product listings page, promotional links to a new search context, and promotional links to other internal and external content pages. Examples of promotional links are merchandising, sponsored advertisements, deals, etc.

Some of the common interactions on the search results page are to include adding/removing constraints to/from the current search context, changing display properties, paginating to the next set of product listings, and starting a new product search attempt. Constraints such as product categories, product attributes (such as brand, color, and size), transactional attributes (such as product location and shipping costs), and keywords in the search query may be added or removed. Display properties of the search results page such as listings per page, sort type, list of displayed product attributes, order of the modules on the page, etc., may be modified by the user. Additionally, the user may choose to paginate to the next or previous set of matching product listings for the current search context.

Furthermore, the user may start a new finding attempt by modifying the search query. This new finding attempt may be related to the previous finding attempt, or may be something unrelated. For example, a related finding attempt could be detected based on addition or removal of keywords from the previous search query. A related finding attempt could also be detected if the current search query belongs to the same product category as the previous search query. Furthermore, any two finding attempts co-occurring within a span of time may be considered as related to one another. All other finding attempts may be marked as unrelated finding attempts.

The list of product listings shown on the search results page may be implemented as a list of condensed versions of the corresponding product listings pages. Any user interaction with this condensed view of a specific product listing on the search results page may be mapped back to the original product listings page.

Some of the common user interactions on the condensed product listings pages in the search results page may include hovering over a specific product listing, and/or clicking on a specific product listing. Some of the common user interactions on the product listings page may include purchasing the product, adding the product to the shopping cart, bidding on the product, adding the product to a list, asking the seller of the product a question, adding the product to a collection/theme of products, submit an offer to buy the product at a price different than the listed price, and sharing of the product listing via social networks. The user may also interact by hovering or clicking on the various modules outlined above in the product listings page.

An operation to determine at least one filter value from the monitored user activities, wherein each filter value is associated with an item listing attribute is executed (block 604). In some embodiments, the item listing attribute comprises a physical attribute of the item. In some embodiments, the item listing attribute comprises a listing attribute identifying the listing as a fixed price listing or an auction-based listing.

An operation to receive a first search query for an item offered for sale through the electronic marketplace from a client machine is executed (block 606). An operation to identify a first plurality of item listings, from a plurality of offered items, satisfying the received first search query is executed (block 608). In some embodiments, the plurality of item listings comprise query results for a plurality of search queries previously submitted by the user during the plurality of data communication sessions (wherein a session comprises a period of activity that a user with a unique IP address spends on a web page for a specified consecutive amount of time).

An operation to narrow the scope of the first plurality of item listings into a second plurality of item listings based, at least in part, on the determined at least one filter value is executed (block 610). An operation to send the second plurality of item listings to the client machine for display is executed (812). In some embodiments, sending the second plurality of item listings to the client machine for display is in response to receiving a user input request to display the second plurality of item listings. In some embodiments, operations to send a plurality of selectable filter values to the client machine for display are to be executed, wherein each filter value, alone or in combination, is to narrow the scope of the first plurality of search results into a second plurality of search results, wherein selectable filter values associated with the determined at least one filter value are displayed as selected.

A shopping experience, especially in an e-commerce marketplace, involves a user applying multiple preferences to tailor the experience to better meet her needs. A typical user generally has a strong affinity towards one or more particular settings of one or more of such preferences. Even if she personally does not apply those preferences frequently during her interactions, such affinity may be apparent from her actual interactions. If such preferences are automatically applied or presented to the user at the beginning of her visit to the e-commerce marketplace, the user may likely find the experience more relevant and more engaging. This may reduce the friction in the experience and may drive overall better experience for the user and more purchases for the marketplace. Embodiments may describe methods and apparatuses to detect, to learn, and to utilize such preferences specific to a user; furthermore, these preferences may be extended to an arbitrary group of users.

In this type of shopping experience, a user may have a specific preference for an attribute of the shopping experience, or for an attribute of a finding attempt, or for an attribute of a desired product listing, etc. Examples of preferences for a shopping experience attribute include a number of product listings per search results page, content language, sort type used on the search results page, etc. Examples of preferences for an attribute of a finding attempt may include product listing condition, product listing format, product listing seller type, product listing shipping costs, etc. Examples of preferences for an attribute of a desired product listing may include warranty, returns accepted, payment method, quality of product images, product rating scores, etc.

Any user preference may be for a specific context, may apply across many/all contexts, or by definition be context-free. Some examples of a context in a shopping experience are the client device of a user (e.g., device properties), geo-location of the user (e.g., raw location, zip code, metro area, known POIs, etc.), temporal context of the user (e.g., raw time, time of the day, day of the week, etc.), business vertical associated with the shopping experience (e.g., electronics, clothing, etc.), another attribute of the finding attempt or product listing (e.g., the user may have a preference for a size given a brand), and a specific finding attempt (e.g., search for an Pink Floyd album, etc.), etc. Some examples of preferences that span many contexts or are context-free are landing page preferences, product location preferences, shipping cost preferences, product quality preferences, etc.

FIG. 7B illustrates another web page 701 of the electronic marketplace displaying search results in response to a received search query 703 according to aspects of the disclosure. As shown in FIG. 7, the exemplary search query 703 includes a search term such as “women's handbags.” The displayed search results includes listings 706-710 that are each selected (from a larger set of listings) to be displayed based, at least in part, on each listing's relevance to the term “women's handbags,” including listings 706-710 that have descriptions that match variations of that term (e.g., “purses” as a variation of “handbags”). In addition, each of the descriptions of the search results may include a title, price, brand identification, etc. A product listings page may include detailed information about the product such as pictures, product attributes, pricing information, seller information, product reviews, transaction information, interaction elements, promotional links to a product listings page, promotional links to a new search context, and promotional link to other internal and external content pages. Examples of promotional links are merchandising, sponsored advertisements, deals, etc. The condensed view of the product listings page may choose to display one or more of the above-mentioned content modules.

In this embodiment, listings 720-723 comprise a second set of listings that are selected for display according to a different metric than that used to select search result listings 706-710. In this embodiment, the listings 720-723 are displayed based, at least in part, on popularity (i.e., different user views) in addition to relevance to the search query 703.

In this embodiment, a plurality of filters 750-762 and corresponding filter values are displayed; these filters 750-762 are selectable for narrowing the scope of displayed search results for search query 703. The filters 750-762 are shown in this example to include a color filter 750, a style filter 752, a brand filter 754, an item condition filter 756, a price filter 758, a listing type filter 760, and an item location filter 762. The price filter characteristic 758 and the item location filter 762 are shown to allow manual user input to configure the filter.

As discussed above, in the event the user does not utilize some or any of filters 750-762, embodiments may infer one or more refinements to help make the results more relevant for the user as the user is interacting with the search platform during a single session. In some embodiments, refinements are further based on item/listing characteristics not listed as a user-selectable filter value.

FIG. 7C illustrates the web page 701 of the electronic marketplace displaying search results (in response to a received search query 703) further narrowed based on the user's interactions with the previously displayed search result listings 706-710 and/or the listings 720-723. In this example, based the user's action on results/listings from previous sessions, it may be inferred that the user is looking for a specific item brand, a specific item condition, and a specific item listing type. For example, the user may have previously executed search query 703 and acted upon several listings having shared characteristics for brand, condition, and listing type. In another example, the user may have acted upon several somewhat related listings (e.g., results for a search query 703 for similar accessories) having shared characteristics for brand, condition, and listing type. Thus, filters 754, 756, and 760 are automatically selected to produce a narrower set of results/listings when the search query 703 is executed in the current session (i.e., based on user actions executed in previous sessions).

In this example, search result listings 706 and 708 are displayed in addition to search result listings 711-713, as these listings match the aforementioned selected filters 754, 756, 760 while the listings 707, 709, and 710 from FIG. 7B do not. Listings 720 and 721 are also displayed with new listings 724 and 725; as discussed above, these listings are selected and displayed based, at least in part, on popularity (i.e., different user views) in addition to relevance to the search query 703 and the aforementioned selected filters 754, 756, 760.

In some embodiments, search results are automatically narrowed based on previous user activity; in other embodiments, search results are selectively narrowed. For example, a decision to automatically narrow search results or suggest narrowed search results to the user may be based on an analysis to determine the likelihood that a user would want the search results narrowed (e.g., a confidence score determined based on analyzing the user activity).

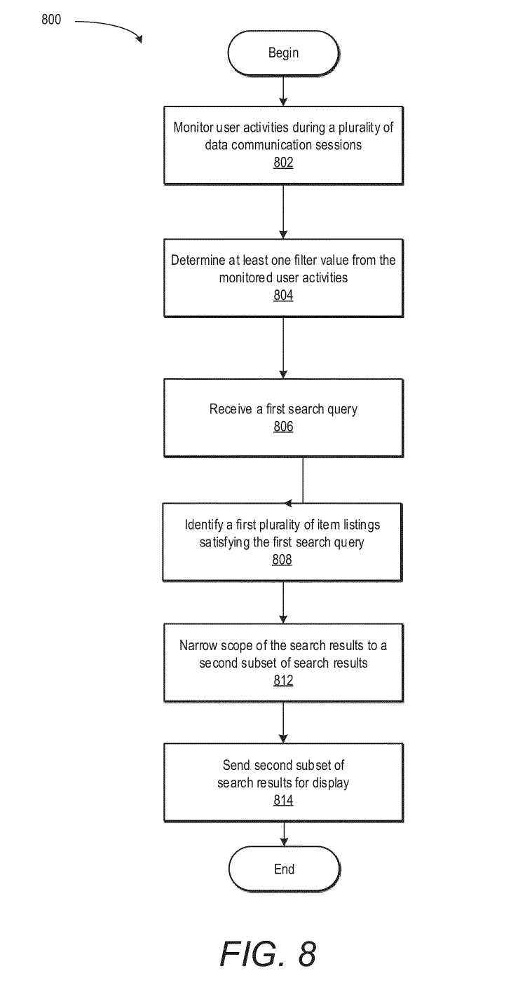

FIG. 8 is another web page 802 of the electronic marketplace displaying search results in response to a received search query 804, according to aspects of the disclosure. In this embodiment, the exemplary search query 804 includes a search term such as “men's athletic shoes.”

In this embodiment, a plurality of filters 850-864 and corresponding filter values are displayed; these filters are selectable for narrowing the scope of displayed search results for search query 804. The filters 850-864 are shown in this example to include a size filter 850, a color filter 852, an item type filter 854, an item condition filter 856, a price filter 858, a listing type filter 860, and an item location filter 862. The price filter characteristic 858 and the item location filter 862 are shown to allow manual user input to configure the filter. In addition, an expandable filter set 864 is displayed to allow the user to further narrow the scope of displayed search results for search query 804.

In this example, based the user's action on the previous results/listings for the same or a similar search, it may be inferred that the user is looking for a specific item brand, a specific item condition, and a specific item listing type. Thus, filters 850, 854, 856, and 860 are selected to produce a narrower set of results and listings for the search query 804 (i.e., in contrast to the results produced without said filters selected).

In this embodiment, a pop-up window 890 is displayed. The pop-up window 890 informs the user what filters have been selected, and if the user wishes to proceed with these narrowed results (if the user declines, these filter values are unselected). The pop-up window 890 may be displayed by default, or may be displayed in response to determining the likelihood that the user would want the search results narrowed (e.g., a confidence score determined based on analyzing the user activity). For example, in some embodiments, the pop-up window 890 is displayed if the search query 804 is, for example, a similar product as a previous search query (i.e., shirts instead of shoes, which are similar in that they are both the same item type—clothing), to ensure the inferred filters are appropriate to apply. In some embodiments, the pop-window 890 is displayed if detected common item listing characteristics fails to meet a high threshold. For example, if the user has performed actions (e.g., viewing a listing, bidding on a listing, etc.) on a percentage of listings across previous sessions having common item listing characteristics (having said item size, style, item condition, and item listing type) that is less than a first value (e.g., less than 80%) but greater than a minimum value (e.g., greater than 50%), some embodiments are to display the pop-up window 890 and inform the user of the inferred filter values can possible produce search results more relevant to the user's current search query. In some embodiments, user actions associated with the threshold quantity of items from the first plurality of item listings includes at least one of a user selection of a listing, a user bid on a listing, a user purchase of a listing, or addition of the listing to a user watch list.

Given the above outlined shopping experience, contexts, and user preferences, embodiments of the disclosure may detect, learn and utilize contextual user preferences. In the shopping experience of an e-commerce marketplace, all interaction of a user may be stored as user session logs or tracking events or any such mechanism of storing user activity. FIG. 9 illustrates a system 900 for executing these operations. In this embodiment, the system 900 is shown to include user activity log 902, parsing engine 904, aggregation engine 906, storage engine 908, recommendation engine 910, and processing engine 912.

In this embodiment, the parsing engine 904 is responsible for receiving user actions/events from the user activity log 902 (shown as operation 951) and parsing this data into all possible preferences of the user in all possible search contexts (shown as operation 952).

The aggregation engine 906 is responsible for aggregation and detection of user preferences. Aggregation across all user actions/events, all search contexts, and all preference types (shown as operation 953) may be implemented in several forms—e.g., simple linear combination of the counts (i.e., quantities of the user actions/events, preference types, etc.), simple non-linear combination of the counts, weighted linear combination of counts, or weighted non-linear combination of counts. The weights may be proportional to a combination of one or more factors such as recentness of the event, importance of the event (e.g., purchase interactions may be weighted as more important than just click interactions), client device for the event, location for the event, time for the event, etc. Standard statistical methods may be used to determine the most likely user preference value for all possible search contexts, along with a confidence score for that value. The most common use case for such aggregation would be to aggregate by user, which could help identify user preferences, given a search context. Furthermore, aggregations may be performed by grouping one or more search contexts so as to identify user preferences given that search context or that group of search contexts. Search contexts can be related to what is being shown to the user in response to a search, and what is being interacted upon by the user, such as product listing categories, product listing formats, product listing conditions, product listing price ranges, and so forth.

Some examples of statistical methods for a categorical variable are the mode of the distribution, and for a continuous variable, the median and the average of the distribution. Furthermore, other well-known statistical inference methods like (maximum a posteriori probability) MAP estimate, maximum-likelihood estimation (MLE) estimate, and so forth can also be used to derive user preferences from a distribution of values.

All of the user preferences outlined above are to be stored in the storage engine 908 (shown as operation 954). The storage engine 908 facilitates easy retrieval of user preferences given a user and one or more search contexts.

The user activity stream provided by user activity log 902 may be available in a real-time or near-real-time fashion to the parsing engine 904. It may further be decided to parse this in near-real-time or periodic fashion (e.g., operation 952 may be executed every hour). This parsed user activity may then further be used to update the user preferences by the aggregation engine 906 in near real-time or periodically. This update may be done by looking at all of the historical user activity data or incrementally by looking at the existing preferences and the new user activity data. The updated user preferences may be stored in the storage engine 908 in near real-time or periodically.

In this embodiment, the recommendation engine 910 queries the storage engine 908 to fetch all eligible user preferences along with their corresponding confidence scores in the given search context/group of search contexts (shown as operations 962 and 963). The recommendation engine 910 determines relevant user preferences in a given search context or a group of search contexts (shown as operation 964). Further, the recommendation engine 910 may remove all the retrieved user preferences that do not meet a minimum threshold value. For example, the minimum eligibility criteria could either be set by the shopping experience administrator or be exposed to the user as a configurable setting.

The recommendation engine 910 may further determine and resolve conflicts between the current explicitly applied preferences by the user and the remaining user preferences fetched from the storage engine 908. In one embodiment, all explicitly applied user preferences are given higher priority. In another embodiment, all preferences obtained by the recommendation engine 910 may be given higher priority. In another embodiment, a configuration system determines for which specific preference the recommendation engine 910 is to override the explicitly applied user preference. In another implementation, the confidence score for a user preference is used to determine if it may override the explicitly applied user preference.

Furthermore, all the resolved user preferences may be ranked. Additionally, using a configurable rank score threshold, a preference may be deemed as mandatory or as optional. The rank score may be computed using the likelihood score and the confidence score of a user preference for a given context or group of contexts. Several strategies may be used to compute this rank score. Some examples are simple linear combination, weighted linear combination, simple non-linear combination, weighted non-linear combination, etc. For example, calculated user preferences based on the distribution of listings shown and the distribution of listings interacted upon (shown=[Electronics: 40, Collectibles: 10, Books: 5]; interacted=[Electronics:0, Collectibles:2, Books:3]) can have a corresponding rank score, wherein the rank score determines if a calculated user preference is to be considered by the recommendation engine 910.

After resolving conflicts and ranking the preferences, the recommendation engine 910 may decide to either apply one or more of the preference in a given context or group of contexts, and may return a ranked list of user preferences to the processing engine 912.

The processing engine 912 processes user requests in the shopping experience, and serve the appropriate response/content for the user. The processing engine 912 sends the current context or group of contexts of the user, and her explicitly applied user preferences, if any, to the recommendation engine 910 (shown as operation 961); and in response, receives a ranked list of user preferences to be applied as outlined above (shown as operation 965). Once the processing engine 912 receives this response, it may augment the current user context or group of contexts with these preferences, and enhance the shopping experience of the user. In one embodiment, all mandatory user preferences are applied by the processing engine 912, and all optional user preferences are suggested to the user by the processing engine 912.

System, methods and apparatuses to learn, detect, and utilize user preferences for a specific user are described above. Other embodiments may extend these methods and apparatus to a group of users instead of a specific user. The grouping of users may be performed along one or more dimensions. Some examples of such dimensions are dominant business vertical, geo-location, temporal contexts, user demographics (age, sex), devices, IP addresses, preferences for specific product attributes (brand, size), customer lifetime value, other business metrics, etc.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any disclosure or concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments utilize more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a parsing engine to:
receive a user activity log for user activities related to a plurality of item listings published via a publication system and monitored during a plurality of data communication sessions between the user and the publication system, each data communication session to comprise a time period of user interactions with the publication system via a client device; and
parse the user activity log to determine one or more user preferences for one or more user contexts;
an aggregation engine to aggregate the one or more user preferences and the one or more user contexts;
a storage engine to store the aggregated user preferences and user contexts;
a recommendation engine to:
query the storage engine for the stored aggregated user preferences and user contexts; and
determine one or more user preferences for a current user context; and
a processing engine to:
process one or more user activities during a current communication session with the user and the publication system; and
provide item listings to be displayed for the user via a client device used during the current session based, at least in part, on the determined one or more user preferences for the current user context.

2. The system of claim 1, wherein the one or more user activities during the current communication session includes a search query submission for an item offered for sale and listed via the publication system, wherein the provided item listings to be displayed for the user comprise a plurality of item listings to satisfy the search query, wherein the one or more user preferences comprises a determined at least one filter value associated with an item listing attribute, and wherein the processing engine is to further:
narrow a scope the plurality of item listings to satisfy the search query based, at least in part, on the determined at least one filter value.

3. The system of claim 2, wherein the processing engine is to further provide a plurality of selectable filter values to the client machine for display, wherein each filter value, alone or in combination, is to narrow the scope of the plurality of search results into a second plurality of search results, and wherein selectable filter values associated with the determined at least one filter value are displayed as selected filter values.

4. The system of claim 1, wherein the user activities stored in the user activities log comprise at least one of a user selection of a listing, a user bid on a listing, a user purchase of a listing, or an addition of a listing to a user watch list.

5. The system of claim 1, wherein the parsing engine is to further:
determine a confidence score associated with each of the determined one or more user preferences; wherein the aggregation engine is to further aggregate one or more user preferences associated with a confidence score exceeding a threshold value.

6. The system of claim 1, wherein the processing engine is to further store the one or more user activities during the current communication session with the user and the publication system for the parsing engine to receive in real time.

7. The system of claim 6, wherein the parsing engine is to parse the user activity log in response to detecting an update to the user activity log.

8. A method comprising:
monitoring user activities related to a plurality of item listings at a publication system during a plurality of data communication sessions between the user and the publication system, each data communication session to comprise a time period of user interactions with the publication system via a client device;
determining at least one filter value from the monitored user activities, wherein each filter value is associated with an item listing attribute;
receiving a first search query for an item offered for sale through the publication system from a client device during a current data communication session;
identifying a first plurality of item listings, from a plurality of offered items, satisfying the received first search query;
narrowing the scope of the first plurality of item listings into a second plurality of item listings based, at least in part, on the determined at least one filter value; and
sending the second plurality of item listings for display to the client device used during the current data communication session.

9. The method of claim 8, wherein user actions include at least one of a user selection of a listing, a user bid on a listing, a user purchase of a listing, or an addition of a listing to a user watch list.

10. The method of claim 8, wherein the plurality of item listings comprise query results for a plurality of search queries previously submitted by the user during the plurality of data communication sessions.

11. The method of claim 8, wherein sending the second plurality of item listings for display is in response to receiving a user input request to display the second plurality of item listings.

12. The method of claim 8, further comprising:
sending a plurality of selectable filter values for display, wherein each filter value, alone or in combination, is to narrow the scope of the first plurality of search results into a second plurality of search results, wherein selectable filter values associated with the determined at least one filter value are displayed as selected filter values.

13. The method of claim 8, wherein the item listing attribute comprises a physical attribute of the item.

14. The method of claim 8, wherein the item listing attribute comprises a listing attribute identifying the listing as a fixed price listing or an auction-based listing.

15. The method of claim 8, wherein the plurality of data communication sessions between the user and the publication system comprise data communication sessions authenticated via a user login identifier (ID).

16. The method of claim 15, wherein the plurality of data communication sessions between the user and the publication system comprise data communication sessions which are further authenticated via a cookie stored on the client device used during the current communication session.

17. A non-transitory machine-useable storage medium embodying instructions which, when executed by a machine, cause the machine to perform a process including operations to:
monitor user activities related to a plurality of item listings at a publication system during a plurality of data communication sessions between the user and the publication system, each data communication session to comprise a time period of user interactions with the publication system via a client device;
determine at least one filter value from the monitored user activities, wherein each filter value is associated with an item listing attribute;
receive a first search query for an item offered for sale through the publication system from a client device during a current data communication session;
identify a first plurality of item listings, from a plurality of offered items, satisfying the received first search query;
narrow the scope of the first plurality of item listings into a second plurality of item listings based, at least in part, on the determined at least one filter value; and
send the second plurality of item listings for display to the client device used during the current data communication session.

18. The non-transitory machine-useable storage medium of claim 17, wherein user actions include at least one of a user selection of a listing, a user bid on a listing, a user purchase of a listing, or an addition of a listing to a user watch list.

19. The non-transitory machine-useable storage medium of claim 18, wherein the plurality of item listings comprise query results for a plurality of search queries previously submitted by the user during the plurality of data communication sessions.

20. The non-transitory machine-useable storage medium of claim 17, wherein sending the second plurality of item listings for display is in response to receiving a user input request to display the second plurality of item listings.
